(19) United States
(12) Patent Application Publication
(10) Pub. No.: US 2004/0137228 A1
(43) Pub. Date: Jul. 15, 2004

(54) Polymer powders for SIB processes

(75) Inventors: Sylvia Monsheimer, Haltern am See (DE); Christian Gerth, Haltern am See (DE); Franz-Erich Baumann, Duelmen (DE); Maik Grebe, Bochum (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/665,472

(22) Filed: Sep. 22, 2003

(30) Foreign Application Priority Data
Sep. 21, 2002 (DE) 102 44 047-6
Mar. 15, 2003 (DE) 103 11 446.7

(51) Int. Cl. B32B 31/00

(52) U.S. Cl. 428/402; 156/60

(57) ABSTRACT

A process of selective inhibition of bonding (SIB) to produce three-dimensional objects is used to obtain high-quality moldings. High-quality moldings can be produced by using pulverulent materials which have a median particle size of from 10 to 200 μm in which at least one polymer or copolymer selected from polyester, polyvinyl chloride, polyacetal, polypropylene, polyethylene, polystyrene, polycarbonate, polymethyl methacrylate (PMMA), PMMI, ionomer, polyamides, copolyester, copolyamides, terpolymers, or ABS, or a mixture of these, is present.

### BACKGROUND OF THE INVENTION

1. Field of the Invention

The invention relates to a polymer powder which can be used for producing three-dimensional objects by means of selective inhibition of bonding (SIB), and to a process in which these powders are used.

2. Description of the Related Art

Very recently a need for the rapid production of prototypes has arisen. Selective laser sintering (SLS) is a process particularly well suited to rapid prototyping. In the SLS process, polymer powders are selectively and briefly irradiated in a chamber with a laser beam. Particles of powder exposed to the laser beam melt. The molten particles fuse and solidify to give a solid mass. Three-dimensional bodies can be produced simply and rapidly by repeatedly applying fresh layers of polymer powder and exposing the fresh layers of polymer powder to the laser beam.

The process of laser sintering (rapid prototyping) to produce moldings from pulverulent polymers is described in detail in U.S. Pat. No. 6,136,948 and WO 96/06881. A wide variety of polymers and copolymers are disclosed to be useful in this application, including for example polyacetate, polypropylene, polyethylene, ionomers, and nylon-11.

Nylon-12 (PA 12) powder has proven particularly successful for producing engineering components by industrial laser sintering. Parts manufactured from PA12 powder meet high mechanical requirements and have properties nearly the same as those of parts produced by mass-production techniques such as injection molding or extrusion.

A material particularly well suited is nylon-12 with a melting point of from 185 to 189° C., an enthalpy of fusion of 112±17 J/g, and a solidification point of from 138 to 143° C., as described in EP 0 911 142 (incorporated herein by reference). It is preferable to use powders whose median particle size is from 50 to 150 μm, for example those obtained as in DE 197 08 946 or else DE 44 21 454 (each of which is incorporated herein by reference).

The SLS process however suffers from high equipment costs, in particular the cost of the laser. Further, the processing speed in laser sintering is relatively slow because large areas have to be scanned by a point light source. These disadvantages have inhibited wide adoption of this process for producing computer-designed objects, and therefore the application of the SLS process currently remains restricted to rapid prototyping. An additional problem with SLS is the process' inability to process colored powders, especially dark-colored powders.

Processes which are capable of use in both rapid prototyping and for manufacturing common household goods have to be significantly simpler to carry out in comparison to SLS, and should in particular be capable of operating without the expensive and complicated apparatus and starting materials required in the conventional process.

Koshnevis (WO 01/38061) has developed a process in which a mass is built up of layers of a powder to be bonded (sintered). After the application of each powder layer, selected regions of the layer are treated with a bonding inhibitor so that bonding takes place only in the regions of the cross section of the three-dimensional article. Bonding (sintering) may take place after each treatment of a layer with a bonding inhibitor. However, it is also possible to sinter the mass, e.g. in an oven, after all of the layers have been completed. Since the regions which are bonded are only those which have not come into contact with the bonding inhibitor, the result is a three-dimensional body having a layered structure.

WO 01/38061 mentions polymer powders and metal powders generally as matrix materials. The disadvantage with most polymer powders is relatively high shrinkage, arising in particular during the sintering of polymer powders. The processing temperatures of some polymer powders are moreover unsuitable in sintering because the high temperatures required during processing can cause technical problems during processing.

### SUMMARY OF THE INVENTION

Accordingly, it is an object of the present invention to provide polymer powders which are particularly well suited for use as a matrix material in the process described in WO 01/38061, for producing three-dimensional objects by means of selective inhibition of bonding.

Surprisingly, it has been found that powders in which polymers or copolymers selected from polyester, polyvinyl chloride, polyacetal, polypropylene, polyethylene, polystyrene, polycarbonate, PMMA, PMMI, ionomer, polyamides, copolyester, copolyamides, terpolymers, or acrylonitrile-butadiene-styrene copolymers (ABS), or a mixture of these, is present, and which have a median particle size of from 10 to 200 μm, are particularly well suited for producing three-dimensional objects by means of selective inhibition of bonding, in particular in processes in which the bonding takes place via radiated heat (sinter processes).

### DETAILED DESCRIPTION OF THE INVENTION

The present invention therefore provides a process for producing a three-dimensional object, which includes:

a) providing a layer of pulverulent material,

b) applying, bonding inhibitors to selected regions of the layer from a), the manner of selection of the regions on which the bonding inhibitor is placed being in accordance with the cross section of the three-dimensional object, and specifically being such that bonding inhibitors are applied only to the regions which are not part of the cross section of the three-dimensional object,

c) repeating steps a) and b) until all of the cross-sectional areas of which the three-dimensional object is composed form a matrix and the outer boundaries of the object are formed by the interface between pulverulent material with applied bonding inhibitor and untreated pulverulent material, and

d) treating the layers at least once so that bonding takes place between pulverulent material not provided with a bonding inhibitor,

wherein the pulverulent material has a median particle size of from 10 to 200 μm and is at least one polymer or copolymer selected from polyester, polyvinyl chloride, polyacetal, polypropylene, polyethylene, polystyrene, polycarbonate, polymethyl methacrylate (PMMA), poly(N-methylmethacrylimide) (PMMI), ionomer, polyamides, copolyester, copolyamides, terpolymers, or acrylonitrile-butadiene-styrene copolymers, or a mixture of these.

The present invention also provides a molding produced by the process of the invention, and pulverulent material which is suitable for use in a process of the invention. Moldings may be sintered shaped bodies.

By using pulverulent material which has a median particle size of from 10 to 200 μm, and in which at least one polymer or copolymer selected from polyacetal, polyvinyl chloride, polypropylene, polyethylene, polystyrene, polycarbonate, PMMA, PMMI, ionomer, polyamides, or a mixture of these, is present, components thus produced have the advantage of exhibiting significantly less shrinkage than components composed of polymer materials which do not meet the abovementioned requirements. The use of pulverulent material within the stated boundaries permits adjustment of the roughness of the surfaces of the moldings produced therefrom.

The use of amorphous or semicrystalline polymers or copolymers whose melting point is above 85° C. and below 200° C. can substantially eliminate any high degree of shrinkage. Furthermore, the use of pulverulent materials where the melting point of the polymers or copolymers is between 85 and 200° C. can make it unnecessary to use an apparatus of complicated design and expensive materials for constructing the apparatus, in particular in relation to thermal insulation or thermal conductivity.

Depending on the inhibitor system used in the process, there may be a preference for some polymers or polymer mixtures. The use of pulverulent material with the specified parameters in the SIB process ensures problem-free treatment of the material with inhibitor without any risk that the inhibitor will wet the pulverulent material outside the desired region, as can, for example, be the case if the bulk density of the pulverulent material is too low.

The present process is unlike the known laser-sintering (SLS) process, insofar as the present process permits production of prototypes or short production runs from materials that comprise colored pigments thereby allowing the mass produced resin to be produced on a small scale or prototype scale. In contrast, when an SLS process is used, the use of dark-pigmented material is impossible due to the use of a laser.

The process of the invention is described below by way of examples, that are not intended to limit the invention.

The process of the invention for producing a three-dimensional object, includes

a) providing or applying a layer of pulverulent material,

b) applying one or more bonding inhibitors to one or more selected regions of the layer from a), the manner in which the bonding inhibitor is placed on the layers corresponding to the cross section of the three-dimensional object to be produced, application is specifically such that bonding inhibitors are applied only to the regions which are not part of the cross section of the three-dimensional object,

c) repeating steps a) and b) until all of the cross-sectional areas form a matrix, and the outer boundaries of the object are formed by the interface between pulverulent material with applied bonding inhibitor and untreated pulverulent material, and

d) treating the layers at least once so that bonding takes place between pulverulent material to which no bonding inhibitor has been applied,

wherein the pulverulent material has a median particle size of from 10 to 200 μm and contains at least one polymer or copolymer selected from polyester, polyvinyl chloride, polyacetal, polypropylene, polyethylene, polystyrene, polycarbonate, PMMA, PMMI, ionomer, polyamides, copolyester, copolyamides, terpolymers, or ABS, or a mixture of these. The pulverulent material may contain only the copolymer or polymer, or may contain additional materials. The process of the invention is based on the process described in WO 01/38061 (expressly incorporated herein by reference). WO 01/38061 provides a detailed description of the functional principle of the SIB process.

A consequence of the application of the bonding inhibitor in step b), which is usually computer-controlled, using CAD applications to calculate the cross-sectional areas, is that only untreated powder particles are bonded in a subsequent treatment step. The inhibitor is therefore only applied to selected regions of the layer from a) where these regions are not part of the cross section of the three-dimensional object to be provided, but rather surround the cross-sectional areas. One example of a method of applying the pulverulent material is with use of a printing head provided with nozzles. After the final treatment step d), the process of the invention gives a matrix with, in part, bonded pulverulent material, revealing the solid three-dimensional object after removal of the non-bonded powder.

The pulverulent layer may be provided by physical or chemical processes. Physical processes include pouring and/or forming and chemical processes include such processes as chemical vapor deposition.

Depending on the manner in which the process of the invention is carried out, treatment may be carried out after each or repeated steps b), and/or after step c). The sequence in relation to the treatment in step d), i.e. the bonding of the pulverulent material, depends on the physical or chemical process used to bond at least some of the pulverulent material. If the treatment in step d) is intended to take place after step c), it has to be ensured that reaction can take place between the pulverulent material not treated with bonding inhibitor in all of the layers. When the process is carried out in this way, the preferred method of bonding the pulverulent material uses heat, a chemical reaction, or a thermally initiated chemical reaction. The use of photons, e.g. UV radiation for crosslinking of pulverulent particles, takes place preferably in those embodiments of the process of the invention in which step d) takes place after every step b).

Available physical processes are any of the processes which permit simultaneous or near-simultaneous bonding of pulverulent material in one or more layers, with the exception of the pulverulent material to which an inhibitor has been applied. Particularly preferred physical processes are those processes in which at least a part of the pulverulent material is sintered or melted. Preferred processes utilize an increase in the temperature which may be achieved by irradiation, in particular using photons, radiated heat, or microwave radiation, by increasing the ambient temperature, by increasing the pressure, and/or by chemical reaction.

Available chemical processes are likewise various chemical reaction processes which permit bonding of at least a part of the pulverulent materials to which an inhibitor has not been applied. These reaction processes may in particular lead to the formation of covalent or ionic bonds between molecules or elements of one or more powder particles with molecules or elements of one or more adjacent powder particles. Examples of suitable reactions are any of the well-known crosslinking reactions or polymerization reactions. Examples of these reactions include free-radical or ionic polymerization, esterification reactions, polyaddition, or polycondensation.

Treating the pulverulent material to cause bonding may also include a combination of chemical and physical processes. For example, the pulverulent material may, at least in part, have reactive groups at the surface which react with one another on heating. When such groups are present, a material which inactivates the reactive groups even without heating may be used as an inhibitor.

Bonding inhibitors include, inter alia, those described in WO 01/38061. For example, inhibitors against bonding induced by radiated heat are particles which reflect radiated heat, for example, metallic inks, silver pigment, or reflective powder, or thermally insulating particles, e.g. ceramic powder or ceramic dispersions. Sintering inhibitors for polymers include oils, alcohols, or waxes having sufficiently high viscosity to form a coherent film around the pulverulent material to inhibit the sintering-together of the pulverulent materials at the sintering temperature. The process of the invention can also use bonding inhibitors whose inhibition of bonding is achieved by forming mechanical barriers between the particles to be melted, or by forming insulating regions between the particles to be fused.

Oils, alcohols, or waxes may likewise be used as inhibitors for chemical reactions. For example, the surface of the pulverulent materials of selective regions of the individual layers may be hydrophobicized, or else hydrophilicized, using one or more of an oil, alcohol, hydrocarbon, water, or another suitable compound, e.g. a silane. If the entire matrix of built-up layers is finally treated with a crosslinking agent, e.g. with an adhesive, e.g. applied by pouring or spraying of the adhesive, or by immersing the matrix in the adhesive, and if the adhesive has hydrophilic or, respectively, hydrophobic properties, bonding then takes place only between the pulverulent materials to which no inhibitor has been applied.

Another example of a suitable inhibitor is hydrogen peroxide, which may react with a polymer used as pulverulent material to alter the surface chemistry of the polymer. It is also possible to use brine as inhibitor. Application of brine leads to the formation of crystals on the particle surface of the pulverulent materials, thereby acting as a chemical, or physical, separator.

Another suitable inhibitor is water, which may comprise additional materials to improve wetting, e.g. surfactants, of the pulverulent material. The water may inhibit physical bonding of the particles, e.g. because the particles do not melt immediately when exposed to heat in the regions where the particles have been treated with water, but instead remain pulverulent due to the cooling action of the vaporizing water, and therefore do not bond. The use of water can also inhibit chemical reactions. For example, water, or a mixture comprising water, e.g. a water/surfactant mixture, may be used in particular to inhibit anionic polymerization in cases where anionic polymerization is the reaction bonding the particles.

Examples of other inhibitors include dyes which, for example, can serve as filters for radiation of a particular wavelength, and thus can inhibit bonding of the particles.

The pulverulent material used preferably comprises a pulverulent material which has been produced by grinding, precipitation, and/or anionic polymerization, or any combinations of these, specifically precipitation of a powder of somewhat too coarse particle size, and subsequent milling, or precipitation, and subsequent classification.

It is particularly preferred that the pulverulent material has a median particle size (d₅₀) of from 10 to 200 μm, particularly preferably from 20 to 100 μm, and very particularly preferably from 40 to 70 μm. Any range or subrange within 10 to 200 μm may be used, e.g., 10-20, 20-40, 20-100, 100-200, 50-150, 10-15 etc. Depending on the intended use, it can be advantageous to use pulverulent materials which comprise particularly small and particularly large particles. In order to obtain three-dimensional articles with maximum resolution and maximum surface smoothness, it can be advantageous to use particles whose median particle size is from 10 to 45 μm, preferably from 10 to 35 μm, very particularly preferably from 20 to 30 μm.

The pulverulent material particularly preferably comprises a polyamide, in particular nylon 12, preferably prepared as described in DE 197 08 946, or else DE 44 21 454 (each of which is incorporated herein by reference), and particularly preferably having a melting point and an enthalpy of fusion as given in EP 0 911 142 (incorporated herein by reference), or comprise a copolyamide or copolyester, e.g. as obtainable with the trademark VESTAMELT® from Degussa AG. The pulverulent material may consist of only nylon-12 or may contain other materials.

Fine material of size below 20 μm, in particular below 10 μm, is difficult to process, because it does not flow freely, and the bulk density falls drastically, with the possible result that more cavities are produced. To ease handling, it can be advantageous to use particles whose median particle size is from 60 to 200 μm, preferably from 70 to 150 μm, and very particularly preferably from 75 to 100 μm. These pulverulent materials may also preferably comprise a polyamide, in particular nylon 12, or comprise a copolyamide, and/or a copolyester, as described above. If significantly coarser powder is used the layer thickness may conflict with particle size and result in insufficient resolution.

The particle size distribution may be selected as desired for the stated median particle sizes of the pulverulent materials. Preference is given to the use of pulverulent materials which have a broad or narrow particle size distribution, preferably a narrow particle size distribution. Mixtures of particles having different particle size distribution may be used (e.g., polymodal distribution). Particularly preferred pulverulent materials for use in the process of the invention have a particle size distribution in which, based on the median particle size, a particle size deviation of more than 50% is present in not more than 20% of the particles, preferably 15%, and very particularly preferably not more than 5%. The particle size distribution can be adjusted by conventional classification methods, e.g. pneumatic separation. Maximum narrowness of particle size distribution in the process of the invention gives three-dimensional objects in which the surface is very uniform and any pores present are very uniform.

At least a part of the pulverulent material used may be amorphous, crystalline, or semicrystalline. Preferred pulverulent material has a linear or branched structure. Particularly preferred pulverulent material has, at least in part, a melting point of from 50 to 350° C., preferably from 70 to 200° C. The inhibition of sintering procedures via the use of oils, alcohols, hydrogen peroxide, water, or brine is very possible in these temperature ranges.

In the process of the invention it is very particularly preferable to use a pulverulent material in which a polyamide, preferably at least one of nylon 6, nylon 11, and/or nylon 12, or a copolyester, or a copolyamide, is present. Polyamides can produce three-dimensional moldings which are particularly dimensionally stable. Particular preference is given to nylon 12 powder, e.g. as described in EP 0 911 142. Preferred copolyamides or copolyesters used are those obtainable with the trademark VESTAMELT from Degussa AG. Particularly preferred copolyamides are those having a melting point of from 76 to 159° C., preferably from 98 to 130° C., and very particularly preferably from 110 to 123° C., determined by differential scanning calometry (DSC). Examples of methods of preparing the copolyamides include polymerization of mixtures of suitable monomers, e.g. those selected from laurolactam and/or caprolactam, as bifunctional component, suberic acid, azeleic acid, dodecanedioic acid, adipic acid, and/or sebacic acid as component bearing an acid function, and 1,6-hexanediamine, isophoronediamine and/or methylpentamethylenediamine as diamine.

In order to achieve better processibility of the pulverulent materials, it can be advantageous to use a pulverulent material which comprises additives. Examples of these additives include flow aids. The pulverulent material particularly preferably comprises from 0.05 to 5% by weight, with preference from 0.1 to 1% by weight, of additives. Examples of flow aids include fumed silicas, stearates, or other flow aids known from the literature, e.g. tricalcium phosphate, calcium silicates, Al₂O₃, MgO, MgCO₃, or ZnO. An example of fumed silica is supplied with the trademark AEROSIL® by Degussa AG.

Together with, or instead of these flow aids, inorganic fillers may also be present in a pulverulent material used according to the invention. Fillers have the advantage that they may substantially retain their shape through the treatment during the bonding process, and thereby reduce shrinkage in the three-dimensional object. In addition, the use of fillers permits, for example, alteration of the plastic properties and physical properties of the objects. For example, the transparency and color of the object, and/or its magnetic properties, can be adjusted by using pulverulent material which comprises metal powders. By way of example, glass particles, ceramic particles, or metal particles may also be present as fillers in the pulverulent material. Typical fillers include granular metals, aluminum powders, steel shot, or glass beads. It is particularly preferable to use pulverulent materials which comprise glass beads as fillers. In one preferred embodiment, the pulverulent material of the invention comprises from 1 to 70% by weight of fillers, preferably from 5 to 50% by weight, and very particularly preferably from 10 to 40% by weight. All ranges and subranges including for example 1-2, 2-4, 5-10, 10-20, 20-40, 25-50 etc. are included.

Together with, or instead of, inorganic flow aids or fillers, inorganic or organic pigments may also be present in the pulverulent material. These pigments may be not only color pigments which determine the perceived color of the three-dimensional body to be generated, but may also be pigments that affect other physical properties of the three-dimensional articles, examples include magnetic pigments, and/or conductivity pigments, e.g. conductivity-modified titanium dioxide or tin oxide, which alter the magnetic properties and, respectively, the conductivity of the article. The pulverulent material particularly preferably comprises inorganic or organic color pigments selected from chalk, ochre, umber, green earth, burnt sienna, graphite, titanium white (titanium dioxide), white lead, zinc white, lithopone, antimony white, carbon black, iron oxide black, manganese black, cobalt black, antimony black, lead chromate, minium, zinc yellow, zinc green, cadmium red, cobalt blue, Prussian blue, ultramarine, manganese violet, cadmium yellow, Schweinfurter green, molybdate orange, molybdate red, chrome orange, chrome red, iron oxide red, chromium oxide green, strontium yellow, metallic-effect pigments, pearlescent pigments, luminescent pigments using fluorescent and/or phosphorescent pigments, umber, gamboge, animal charcoal, Cassel brown, indigo, chlorophyll, azo dyes, indigoids, dioxazine pigments, quinacridone pigments, phthalocyanine pigments, isoindolinone pigments, perylene pigments, perinone pigments, metal complex pigments, alkali blue pigments, and dicetopyrrolopyrrole. Further information concerning pigments which may be used may be found in, for example, Römpp Lexikon Chemie [Römpp Chemical Encyclopedia]—Version 2.0, Stuttgart/New York; Georg Thieme Verlag 1999, and also in the references given in that publication. The particle sizes of the pigments used may be those described for the pulverulent material. However, the pigments frequently have particle sizes significantly smaller than the median particle sizes of the polymers used. The pigments may, for example, be applied in a manner similar to that for the bonding inhibitors such as through nozzles used in printing heads, or may be present in the polymer particles. The pulverulent material of the invention particularly preferably comprises polymer particles which comprise one or more of the pigments mentioned—preferably with the exception of white pigments alone. The proportion of the pigments in the pulverulent material is preferably from 0.01 to 25% by weight, preferably from 0.1 to 10% by weight, and particularly preferably from 1 to 3% by weight.

In the process of the invention, the moldings produced therefrom may have one or more functionalized layers. By way of example, functionalization, e.g. the provision of conductive properties to the entire molding, or else only to certain regions, may take place by applying appropriate pigments or substances to the layer or pulverulent material, using a method similar to that for the inhibitor.

One embodiment of the process of the invention, use includes of bonding inhibitors whose action is only temporary. These bonding inhibitors may be frames, plates, sheets, or glass materials of various shape, where these may comprise two or more parts, and where, after application of the powder, bonding inhibitors protectively cover regions of the powder layer in the manner of a frame. By using a large number of different shapes, or by using flexible shapes which can be adapted by computer control to the area to be protectively covered, it is possible to provide protective covering for almost any conceivable cross-sectional area. The pulverulent material in the area not protectively covered is bonded, together and to adjacent underlying layers, by exposure to radiation, in particular radiated heat, or by spraying with a chemical. The temporary bonding inhibitors are then removed, and a fresh layer of pulverulent material is applied. This embodiment of the process of the invention also gives a three-dimensional article by repeating the steps of the process as required by the number of cross-sectional areas. The pulverulent materials used may be the abovementioned materials.

Moldings which can be produced by the process of the invention can have any desired three-dimensional shape which can be formed by layers. The molding particularly preferably comprises a nylon 12, a copolyamide, or a copolyester. Moldings produced using the process of the invention preferably comprise at least one filler selected from glass beads or aluminum powder. Moldings which can be produced by means of the process of the invention are in particular those whose color is neither white nor transparent (nor transparent with a milky or yellowish effect). Moldings with these colors cannot be produced using conventional laser-sintering processes, because the color pigments impair the supply of energy by the laser. The moldings produced according to the invention may also have functionalized layers. Besides functionalization through pigments, there may also be compounds with particular functional properties present in one or more of the layers, or in the entire molding. An example of functionalization may consist in provision of electrically conducting properties to the entire molding, to one or more layers of the molding, or else only to parts of one or more layers of the molding. This functionalization may be achieved through conductive pigments, e.g. metal powders, or through the use of conductive polymers, e.g. polyaniline. Moldings which have conductor tracts can be obtained in this way, and these may be present either on the surface or else within the molding.

The present invention also provides the pulverulent material as described above, suitable for use in the process of the invention, and in which, in particular, the median particle size is from 10 to 200 μm, and in which at least one polymer or copolymer selected from polyvinyl chloride, polyester, polyacetal, polypropylene, polyethylene, polystyrene, polycarbonate, PMMA, PMMI, ionomer, polyamides, copolyester, copolyamides, terpolymers, or ABS, or a mixture of these, is present. The powder particularly preferably comprises nylon 12, a copolyamide, or a copolyester, or a mixture of these. The powder particularly preferably comprises polymer particles which have been colored, their color being other than white.

### EXAMPLES

Triangular objects with edge length 50×50 mm were produced by means of the process of the invention for the selected inhibition of bonding. For this, a square metal frame with internal dimensions of 50 mm and external dimensions of 100 mm, with a thickness of 1 mm, was placed on a continuous metal plate. The resultant aperture was then filled with powder and another metal plate was used for smoothing. One half of the rectangle was then protectively covered, using a flexible metal plate. The remaining powder surface was then uniformly wetted, by spray-application, using an air-brush gun, with water which had been treated with 10% by weight of a washing composition (Pril, Henkel). After removal of the protective covering, the entire powder layer was heated for 2 and, respectively, 5 seconds at a distance of 2 cm from a radiant heater from the company AKO, having a power rating of 1000 watts. This gave a powder layer including as component, a triangular structure comprising sintered powder. The powder which was present around the component and which was treated with the water comprising washing composition during the production process remained in powder form. The component could be removed without difficulty from the powder layer. Table 1 below lists the powders tested, and the results of the experiments.

TABLE 1

| | | Melting | |
|---|---|---|---|
| | | point | |
| Pulverulent | | (DSC) in | |
| material | Trade name | ° C. | Result |
| Copolyamide | Vestamelt X1310 | 110 | No curl, good sinterability, |
| | | | sharp edges |
| PA12 | EOSINT PA | 186 | Good sinterability, slight |
| | 2200 | | curl |
| PA612 | Vestamid D16 | 216 | Sinterable |
| Copolyester | Vestamelt 4481 | 107 | Good sinterability |
| Copolyamide | Vestamelt 840 | 113 | Very good sinterability, |
| | | | the inhibitor-covered |
| | | | parts also sintered when |
| | | | using 5 seconds of |
| | | | irradiation; when using 5 |
| | | | seconds and a distance of |
| | | | 10 cm, edges were not |
| | | | sharp |
| PE | Vestolen A6016 | | Good sinterability, curl |
| EPVC | Vestolit P1403 K | | Sinterable, discoloration |
| MPVC | Vestolit P2004 | | Sinterable, |
| | KF | | discoloration |

The abbreviations MPVC and EPVC indicate the PVC production method: MPVC represents mass-polymerized polyvinyl chloride, and EPVC represents emulsion-polymerized polyvinyl chloride. PE represents polyethylene.

The products with the Vestamelt and Vestamid can be purchased from Degussa AG. The product EOSINT PA 2200 can be purchased from EOS GmbH Electro Optical Systems. The product Vestolen is obtainable via Sabic EPC, and the products with the name Vestolit are obtainable via Vestolit GmbH & Co KG. The abovementioned product names are registered trademarks of the respective stated companies, with the exception of the name Vestolen, which is registered as a trademark of DSM Polyolefin GmbH, Gelsenkirchen, Germany.

German applications 10244047.6 and 1031146.7 filed on Sep. 21, 2002 and Mar. 15, 2003, respectively, are each incorporated herein by reference in their entireties.

Obviously, numerous modifications and variations of the present invention are possible in light of the above teachings. It is therefore to be understood that within the scope of the appended claims, the invention may be practiced otherwise than as specifically described herein.

1. A process for producing a three-dimensional object, comprising:
a) providing a layer of a pulverulent material,
b) applying one or more bonding inhibitors to one or more regions of the layer wherein the regions to which the bonding inhibitor is applied are the cross section regions of the three-dimensional object, and wherein no bonding inhibitor is applied to regions which are not the cross section regions of the three-dimensional object,
c) repeating a) and b) until all of the cross-section regions of the three-dimensional object are a matrix of inhibitor-applied pulverulent layer regions, wherein the outer boundaries of the three-dimensional object are the interface between inhibitor-applied pulverulent material and pulverulent material without applied inhibitor, and
d) treating the layers at least once to bond the pulverulent material which does not have applied inhibitor,
wherein the pulverulent material has a median particle size of from 10 to 200 μm and comprises at least one selected from the group consisting of a polyester, a polyvinyl chloride, a polyacetal, a polypropylene, a polyethylene, a polystyrene, a polycarbonate, PMMA, PMMI, an ionomer, a polyamide, a copolyester, a copolyamide, a terpolymer, ABS and a mixture thereof.

2. The process as claimed in claim 1, wherein d) is carried out after b).

3. The process as claimed in claim 1, wherein d) is carried out after c).

4. The process as claimed in claim 1, wherein the pulverulent material is obtained by grinding, precipitation, anionic polymerization, or a combination thereof, with optional subsequent fractionation thereof.

5. The process as claimed in claim 1, wherein the pulverulent material comprises at least one of nylon-6, nylon-11 or nylon-12.

6. The process as claimed in claim 1, wherein the pulverulent material is amorphous or semicrystalline.

7. The process as claimed in claim 1, wherein the pulverulent material has a linear or branched structure.

8. The process as claimed in claim 1, wherein at least a portion of the pulverulent material has a melting point of from 50 to 350° C.

9. The process as claimed in claim 1, wherein at least a portion of the pulverulent material has a melting point of from 70 to 200° C.

10. The process as claimed in claim 1, wherein the pulverulent material has a median particle size of from 20 to 100 μm.

11. The process as claimed in claim 1, wherein the pulverulent material comprises from 0.05 to 5% by weight of one or more flow aids.

12. The process as claimed in claim 1, wherein the pulverulent material comprises one or more inorganic fillers.

13. The process as claimed in claim 12, wherein the fillers comprise glass beads.

14. The process as claimed in claim 1, wherein the wherein pulverulent material comprises one or more inorganic pigments, organic pigments, or both.

15. The process as claimed in claim 1, wherein the bonding inhibitor comprises a material with wetting properties.

16. The process as claimed in claim 1, wherein the bonding inhibitor comprises at least one liquid selected from the group consisting of water, an oil, and an alcohol.

17. The process as claimed in claim 1, wherein the bonding inhibitor temporarily inhibits bonding.

18. The process as claimed in claim 1, wherein the bonding inhibitor comprises water and at least one surfactant.

19. The process as claimed in claim 1, further comprising
inhibiting bonding of the inhibitor-applied pulverulent layers by vaporization and cooling.

20. The process as claimed in claim 1, further comprising
inhibiting bonding of the inhibitor-applied pulverulent layers by forming one or more mechanical barriers between the particles of pulverulent material of the inhibitor-applied pulverulent layers.

21. The process as claimed in claim 1, further comprising
inhibiting bonding of the inhibitor-applied pulverulent layers by forming one or more thermally insulating regions between the particles of pulverulent material of the inhibitor-applied pulverulent layers.

22. A molding produced by the process as claimed in claim 1.

23. The molding as claimed in claim 22, comprising one or more of a nylon-12, a copolyamide, or a copolyester.

24. The molding as claimed in claim 22, further comprising at least one filler selected from the group consisting of glass beads and aluminum powder.

25. A pulverulent material having a median particle size from 10 to 200 μm, comprising at least one selected from the group consisting of a polyester, a polyvinyl chloride, a polyacetal, a polypropylene, a polyethylene, a polystyrene, a polycarbonate, PMMA, PMMI, an ionomer, a polyamide, a copolyester, a copolyamide, a terpolymer, ABS, and a mixture thereof.

26. The pulverulent material as claimed in claim 25, comprising colored polymer particles having a color that is not white.
